(19) United States
(12) Patent Application Publication
(10) Pub. No.: US 2022/0372176 A1
(43) Pub. Date: Nov. 24, 2022

(54) POLYMER DISPERSIONS SUITABLE FOR FABRIC CONDITIONING TREATMENT

(71) Applicant: RHODIA OPERATIONS, Lyon (FR)

(72) Inventors: David James Wilson, Coye-La-Forêt (FR); Pierre-Emmanuel Dufils, Paris (FR); Jean-Christophe Castaing, Sèvres (FR)

(73) Assignee: RHODIA OPERATIONS, Lyon (FR)

(21) Appl. No.: 17/766,059

(22) PCT Filed: Sep. 23, 2020
(86) PCT No.: PCT/EP2020/076627

§ 371 Date: Apr. 1, 2022

(30) Foreign Application Priority Data
Oct. 3, 2019 (EP) 19306273.4

(51) Int. Cl. C08F 2/16; C11D 3/00; C11D 3/37; C08L 53/00; C09K 23/16

(52) U.S. Cl. CPC C08F 2/16; C11D 3/0015; C11D 3/3773; C08L 53/005; C09K 23/16; C08L 2201/54

(57) ABSTRACT

The present invention relates to a process for preparing a dispersion (D°), comprising: (E1) a polymerization performed M in an aqueous medium in the presence of: ° at least a pre-polymer (pO) of formula (R¹¹)X—Z¹¹—C(═S)—Z¹²-[A]-R¹², which is soluble in the aqueous medium ° at least one free-radical polymerization initiator; and ° at least one ethylenically unsaturated hydrophobic monomer (m) with a ratio m/pO of the mass of the monomers (m) to the quantity of pre-polymer (pO) preferably below 10 000 g/mol whereby a dispersion of copolymers is obtained, including polymers with a living character; (E2) a conversion of the terminal groups of the copolymers that deprive the copolymers of their living character. The invention also relates to the use of dispersion (D°) for forming dispersions of hydrophobic polymers (Dp), suitable e.g. in fabric conditioning compositions.

The present invention relates to polymer dispersions that are especially suitable as dispersing agents for hydrophobic monomers in a hydrophilic medium, especially in water, and to methods making use of such dispersions. In this connection, the invention notably relates to emulsion polymerization of hydrophobic monomers and preparation of fabric conditioning compositions.

More precisely, the instant invention relates to aqueous dispersions of bloc polymers comprising a hydrophilic bloc and a short hydrophobic bloc, said dispersions comprising the bloc polymers in the form of micelles, or micelle-like structures, and made of bloc polymers organized with an outer hydrophilic “shell” and an inner hydrophobic “core”.

The term “aqueous dispersion” herein refers to dispersion in water, or alternatively in a water soluble medium that preferably comprises at least 50% of water, by weight based on the total weight of the water soluble medium (it may be an aqueous solution of salt or it may comprise a water soluble solvent such as ethanol for example). In the instant description, for sake of concision, the dispersant medium of an aqueous dispersion will be referred as “aqueous medium” in all cases (whatever this dispersion medium is, pure water or a water soluble medium).

One aim of the invention is to provide aqueous dispersions of the aforementioned type, that, among other possible advantages, have the ability to maintain hydrophobic monomers, in a dispersed state, when such monomers are mixed with the dispersions.

To this end, according to a first aspect, one subject-matter of the instant invention is a process for preparing a dispersion (herein referred as “dispersion D⁰”), that comprises the following successive steps: (E1) a free radical polymerization is performed in an aqueous medium (M) in the presence of:
at least a pre-polymer (p0) soluble in the medium (M), having the following formula (I):

(R¹¹)ₓ—Z¹¹—C(—S)—Z¹²-[A]-R¹² (1)
wherein:
Z¹¹ represents C, N, O, S or P,
Z¹² represents S or P,
R¹¹ and R¹², which may be identical or different, represent:
   an optionally substituted alkyl, acyl, aryl, alkene or alkyne group (i), or
   a saturated or unsaturated or aromatic, optionally substituted carbon-based ring (ii), or
   a saturated or unsaturated, optionally substituted, heterocycle (iii), these groups and rings (i), (ii) and (iii) being possibly substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
   R representing an alkyl or aryl group,
x corresponds to the valency of Z¹¹, or alternatively x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR₂); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts); and
[A] represents a polymer chain; and
at least one free-radical polymerization initiator; and
at least one ethylenically unsaturated hydrophobic monomer (m)
   with a ratio m/p0 corresponding to ratio of the mass of the monomers (m) to the quantity (in mole) of pre-polymer (p0) preferably of at most 10 000 g/mol, typically between 5 000 and 10 000 g/mol.
   whereby a dispersion of copolymers is obtained, including polymer chains having a (R¹¹)ₓ—Z¹¹—C(═S)—Z¹²— terminal group, that confer to these chains a living character;
and then
   (E2) the (R¹¹)ₓ—Z¹¹—C(═S)—Z¹²— terminal groups present in the dispersion of copolymers as obtained in step (E1) are converted into other groups that deprive the copolymers of their living character.

According to another aspect, a subject-matter of the invention is the dispersion D⁰ as obtained according to the aforementioned process.

The step (E1) of the process of the invention is a specific radical polymerization process that makes use of a pre-polymer (p0) that has a so-called “living” character, due to the specific (R¹¹)ₓ—Z¹¹—C(═S)—Z¹²— terminal group carried by this pre-polymer. This living character is well-known as such (for more details, reference may e.g. be made to the Handbook of RAFT Polymerisation, Weinheim, WILEY-VCH Verlag GmbH & Co. 2008. Concretely, the living character of the polymerization of step (E1) implies that the polymer chain [A] carried by the pre-polymers (p0) are schematically extended by incorporation of the monomers (m) implemented in step (E1), between the chain [A] and the terminal group, whereby copolymers are obtained, that are terminated by the same (R¹¹)ₓ—Z¹¹—C(═S)—Z¹²— terminal group that imparts the same living character to the chains obtained at the end of step (E1).

Besides, the use of the specific pre-polymer (p0) carrying the specific (R¹)ₓ—Z¹¹—C(═S)—Z¹²-terminal group also lead to a radical polymerization having a controlled character: during step (E1), in the ideal case, the polymer chains virtually grow at the same speed and schematically, only on the given sites constituted by the existing chain [A] present on the pre-polymer. This leads to a controlled incorporation of the monomers (m), and therefore the formation of bloc copolymers wherein the hydrophobic blocs have substantially the same length: in theory, a length corresponding to the ratio m/p0 as defined hereinabove. In practice, a population of distinct polymer is obtained, but the controlled character of the polymerization leads to a polydispersity index that remains low, with the thus obtained hydrophobic blocs that are very close to the theory in terms of targeted number average molar mass.

In addition, the specific use in step (E1) of, on the one hand, a pre-polymer (p0) soluble in the aqueous medium (M); and, on the other hand, a hydrophobic monomer significantly less soluble with this medium, leads to a specific polymerization, wherein the polymer becomes progressively less and less compatible with the medium (M) as the polymerisation progresses, since the polymer incorporates more and more hydrophobic constituents. As a result, a dispersion is obtained due to the fact that the hydrophobic blocs of the obtained copolymers tend to self-organize in order to decrease the contact of the hydrophobic bloc with the aqueous medium (M).

The step (E1) is specifically carried out with a sufficient quantity of monomers (m) to obtain such a dispersion, but with a limited length of the hydrophobic bloc, typically with a ratio m/p0 that is preferably below 10 000 g/mol. This m/p0 ratio of the mass of the monomers (m) to the quantity (in mole) of pre-polymer (p0) is more preferably between 5 000 and 10 000 g/mol, for example between 6 000 and 9 000 g/mol.

The step (E2) of the process induces only a change in the the copolymers as obtained at the end of step (E1), namely they are reacted in order to deprive them of their living character. Such a “deactivation” of living polymer is well-known per se and examples of methods are given hereinafter.

Therefore, at the end of step (E2), a very specific dispersion is obtained, herein referred as “dispersion D⁰” that contains micelles or micelle-like objects with an outer hydrophilic shell and an inner hydrophobic core, these micelles or micelle-like objects being made of bloc polymers, that are not living, but which however have a controlled structure and notably a controlled length of their short hydrophobic bloc.

The dispersion D⁰ as obtained according to the instant invention may be useful as such (for example, it may acts as a fabric conditioning composition if the hydrophobic monomers (m) are properly chosen), but it is also useful for preparing a more complex dispersion.

In this connection, another subject-matter of the invention is the use of the dispersion D⁰ as described above for dispersing hydrophobic species in an aqueous medium.

When a dispersion D⁰ as obtained according to the aforementioned steps (E1) and (E2) is contacted with hydrophobic monomers (for example by adding such monomers to the dispersion D⁰), said hydrophobic monomers migrate in contact with the hydrophobic parts of the polymers dispersed within the aqueous medium of said dispersion, whereby a dispersion is obtained (referred as “dispersion D” hereinafter), that comprises the hydrophobic monomers, stabilized by the polymers of the dispersion D⁰. The dispersion (D) may optionally comprise other hydrophobic species in addition to the hydrophobic monomers.

In other words, according to another specific aspect, another specific subject-matter of the instant invention is a process for preparing a dispersion (D) of hydrophobic monomers in an aqueous medium. This process comprises the preparation of a aforementioned steps (E1) and (E2), whereby a first dispersion of bloc copolymers (D⁰) is obtained, and then an additional step (E3) wherein said dispersion D⁰ is contacted with the hydrophobic monomers. Another subject-matter of the invention is the so obtained dispersion (D).

The dispersion (D) is generally used for implementing a polymerization of the hydrophobic monomers. In this connection, the invention provide a process for preparing a polymer latex that comprises a step (E4) wherein all of part of the hydrophobic monomers contained in a dispersion (D) of the aforementioned type are polymerized. In that respect, a specific subject-matter of the invention is a process for preparing a polymer latex (Dp) that comprises: the preparation of a dispersion (D⁰) as described above; a step (E3) wherein said dispersion D⁰ is contacted with hydrophobic monomers leading to a dispersion (D) of said hydrophobic monomers; and then (E4) a polymerization of all or part of the hydrophobic monomers

The aforementioned successive steps (E1), (E2) and (E3) wherein the hydrophobic monomers are monomers and then a step (E4) of polymerization of the monomers, typically a radical polymerization carried out by adding a radical initiator in the dispersion (D) comprising the hydrophobic monomers as obtained in step (E3). A dispersion of polymer, referred herein as “dispersion (Dp)” or “latex (Dp)” which is a polymer latex is then obtained in step (E4), that is another specific subject-matter of the instant invention.

In the dispersion (Dp) as obtained in step (E4), the hydrophobic polymer chains are stabilized by the copolymers as obtained in step (E2). Unless any phenomenon of chain transfer occurs, the stabilizing copolymer does not interfere with the polymerization of the monomers used in step (E4) since these copolymers have lost their living character in step (E2).

According to a specific embodiment, the dispersions (Dp) prepared according to step (E4) may be used in a fabric conditioning compositions. In that case, the hydrophobic species present in the dispersion (D) are chosen among species able to impart a proper treatment of the fabrics, especially of cotton fibers. Examples of proper species are given herein below as non-limitative possible examples.

Specific features and advantageous embodiments of the invention are described in more details herein below.

Step (E1): Preparation of a Dispersion of Living Copolymers

The step (E1) is a polymerization step that leads to a living block copolymer having a controlled internal structure and in the form of a suspension. The step (E1) may be performed batch or semi-batch.

As discussed hereinabove, a dispersion in step (E1) is obtained due to the specific use of the soluble pre-polymer (p0) and the hydrophobic monomers (m). The step (E1) can therefore be implemented without any surfactant in addition to the pre-polymer (p0) and the monomers (m) which constitute an advantage of the suspension of the invention since additional surfactant often limit the domains where the dispersion may be used.

When no additional surfactant is used, the polymerization of the hydrophobic monomers (m) can be performed directly in batch ab initio conditions using pre-polymer (p0) soluble in the specific medium (M). Amphiphilic block copolymers thereby form and self-assemble into self-stabilized dispersions within the course of the polymerization by polymerization-induced self-assembly (PISA). In other words, dispersions according to the instant invention are then made via a macro-molecular self-assembly of polymeric emulsifiers.

In some specific cases, the use of additional surfactants may however be contemplated in step (E1). Even if not compulsory, it may be of interest in some cases, to add surfactant in addition to the pre-polymer (p0) and the monomers (m), depending on the final application intended for the dispersion. The surfactants may then be chosen from, but not limited to, ionic, non-ionic and amphoteric surfactants, such as polyvinyl alcohols, fatty alcohols or alkylphenol sulfates or sulfonates, alkylbenzene sulfonates, for example dodecylbenzene sulfonate, sulfosuccinates, quaternary ammonium salts or ethylated fatty alcohol. When additional surfactants are used in step (E1), there are preferably present at a concentration below 10%, by weight based on the total weight of the reaction medium. Typically, from 0.1% to 10% of surfactant may be used, preferably less than 8%, notably less than 5%, by weight based on the total weight of the reaction medium.

The Pre-Polymer (p0)

The so-called “pre-polymer” (p0) used in step (E1) is in fact a relatively short polymer chain having specific terminal groups that allow an extension of the polymer chain during step (E1), thus leading to a compound carrying a longer polymer. The pre-polymer (p0) is typically used in step (E1) as a macro-transfer agent.

The pre-polymer (p0) used in step (E1) is specifically soluble in a medium (M), which means that the pre-polymer may be solubilized in the medium (M) without phase separation on the macroscopic scale at the pre-polymer concentration used in step (E1), in the absence of the monomer (m). Concretely, the pre-polymer (p0) is solubilized in medium (M) at the beginning of step (E1).

To this end, the polymer chain [A] included in the pre-polymer (p0) is soluble in the medium (M). The exact nature of the polymer chain [A] may vary to quite a large extent and it can be adjusted, case by case, according to the medium (M) used and the final application(s) contemplated for the prepared dispersion.

Typically, the polymer chain [A] included in the pre-polymer (p0) can be selected from the homo- and copolymers (random, gradient or block) resulting from the polymerization of at least one or more hydrophilic monomers (mAₕ) selected from:
unsaturated carboxylic acid amides, such as acrylamide, methacrylamide, N-methylolacrylamide or -methacrylamide, N-alkyl(meth)acrylamides, N,N-dimethyl(meth)acrylamide, N,N-dimethylaminomethyl(meth)acrylamide, 2-(N,N-dimethylamino)ethyl(meth)acrylamide, 3-(N,N-dimethylamino)propyl(meth)acrylamide, or 4-(N,N-dimethylamino)butyl(meth)acrylamide,
vinylamine amides, in particular vinylformamide, vinylacetamide, N-vinylpyrrolidone and N-vinylcaprolactam,
α,β monoethylenically unsaturated amino esters, such as 2-(dimethylamino)ethyl acrylate (ADAM), 2-(dimethylamino)ethyl methacrylate (DMAM or MADAM), 3-(dimethylamino)propyl methacrylate, 2-(tert-butylamino)ethyl methacrylate, 2-(dipentylamino)ethyl methacrylate, or 2-(diethylamino)ethyl methacrylate, vinylpyridines,
vinylimidazolines,
ethylenically unsaturated monocarboxylic and dicarboxylic acids, such as acrylic acid, methacrylic acid, itaconic acid, maleic acid or fumaric acid,
monomers carrying at least one vinyl phosphonate function, such as vinylphosphonic acid, vinylphosphonic acid dimethyl ester, vinylphosphonic acid bis(2-chloroethyl) ester, vinylidenediphosphonic acid, vinylidenediphosphonic acid tetraisopropyl ester or alpha-styrenephosphonic acid, or mixtures thereof, mixtures of two or more of these monomers,
ammoniumacryloyl or acryloyloxy monomers,
trimethylammoniumpropylmethacrylate salts, in particular the chloride,
trimethylammoniumethylacrylamide or -methacrylamide chloride or bromide,
trimethylammoniumbutylacrylamide or -methacrylamide methylsulfate,
trimethylammoniumpropylmethacrylamide methylsulfate (MAPTA MeS),
(3-methacrylamidopropyl)trimethylammonium chloride (MAPTAC),
(3-acrylamidopropyl)trimethylammonium chloride or methylsulfate (APTAC or APTA MeS),
alkyl-polyalkoxylated (meth)acrylates that comprise one linear or branched (C5-C40)alkyl-polyethoxylated group, more typically (C10-C22)alkyl-polyethoxylated group per molecule, such as decyl-polyethoxylated (meth)acrylates, tridecyl-polyethoxylated (meth)acrylates, myristyl-polyethoxylated (meth)acrylates, cetyl-polyethoxylated (meth)acrylates, stearyl-polyethoxylated (methyl)acrylates, eicosyl-polyethoxylated (meth)acrylates, behenyl-polyethoxylated (meth)acrylates, even more typically decyl-polyethoxylated methacrylates, tridecyl-polyethoxylated methacrylates, myristyl-polyethoxylated methacrylates, cetyl-polyethoxylated methacrylates, stearyl-polyethoxylated methylacrylates, eicosyl-polyethoxylated methacrylates, behenyl-polyethoxylated methacrylates, and mixtures thereof,
methacryloyloxyethyltrimethylammonium chloride or methylsulfate,
acryloyloxyethyltrimethylammonium (ADAMQUAT) salts, such as acryloyloxyethyltrimethylammonium chloride or acryloyloxyethyltrimethylammonium methylsulfate (ADAMQUAT CI or ADAMQUAT MeS),
methyldiethylammoniumethyl acrylate methylsulfate (ADAEQUAT MeS),
benzyldimethylammoniumethyle acrylate chloride or methylsulfate (ADAMQUAT BZ 80),
1-ethyl 2-vinylpyridinium bromide, chloride or methylsulfate or 1-ethyl 4-vinylpyridinium bromide, chloride or methylsulfate,
N,N-dialkyldiallylamine monomers, such as N,N-dimethyldiallylammonium chloride (DADMAC),
dimethylaminopropylmethacrylamide, N-(3-chloro-2-hydroxypropyl)trimethylammonium chloride (DIQUAT chloride),
dimethylaminopropylmethacrylamide, N-(3-methylsulfate-2-hydroxypropyl)-trimethylammonium methylsulfate (DIQUAT methylsulfate),
the monomer of formula

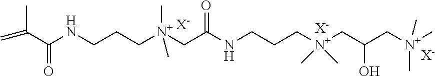

where X⁻ is an anion, preferably chloride or methylsulfate,

Alternatively, the hydrophilic monomers (mAₕ) may comprise monomers selected from:
esters of α,β-ethylenically unsaturated monocarboxylic and dicarboxylic acids with C2-C3 alkanediols, for example 2-hydroxyethyl acrylate, 2-hydroxyethyl methacrylate, 2-hydroxyethyl ethacrylate, 2-hydroxypropyl acrylate, 2-hydroxypropyl methacrylate, 3-hydroxypropyl acrylate, 3-hydroxypropyl methacrylate and polyalkylene glycol(meth)acrylates, glycerol (meth)acrylate;
α,β-ethylenically unsaturated monocarboxylic acid amides and the N-alkyl and N,N-dialkyl derivatives thereof, such as acrylamide, methacrylamide, N-methyl(meth)acrylamide, N-ethyl(meth)acrylamide, N-propyl(meth)acrylamide, N,N-dimethyl(meth)acrylamide, N,N-diethyl(meth)acrylamide, morpholinyl(meth)acrylamide, and metholylacrylamide (acrylamide and N,N-dimethyl(meth)acrylamide prove to be in particular advantageous);
N-vinyllactams and derivatives thereof, for example N-vinylpyrrolidone and N-vinylpiperidone;
open-chain N-vinylamide compounds, for example N-vinylformamide, N-vinyl-N-methylformamide, N-vinylacetamide, N-vinyl-N-methylacetamide, N-vinyl-N-ethylacetamide, N-vinylpropionamide, N-vinyl-N-methylpropionamide and N-vinylbutyramide;
esters of α,β-ethylenically unsaturated monocarboxylic and dicarboxylic acids with aminoalcohols, for example N,N-dimethylaminomethyl(meth)acrylate, N,N-dimethylaminoethyl(meth)acrylate, N,N-diethylaminoethyl acrylate, and N,N-dimethylaminopropyl(meth)acrylate;
amides of α,β-ethylenically unsaturated monocarboxylic and dicarboxylic acids with diamines comprising at least one primary or secondary amino group, such as N-[2-(dimethylamino)ethyl]acrylamide, N[2-(dimethylamino)ethyl]methacrylamide, N-[3-(dimethylamino)propyl]acrylamide, N-[3-(dimethylamino)propyl]methacrylamide, N-[4-(dimethylamino)butyl]acrylamide and N-[4-(dimethylamino)butyl]methacrylamide;
ethylenically unsaturated carboxylic acids, sulfonic acids and phosphonic acids, and/or derivatives thereof such as acrylic acid (AA), methacrylic acid, ethacrylic acid, α-chloroacrylic acid, crotonic acid, maleic acid, maleic anhydride, itaconic acid, citraconic acid, mesaconic acid, glutaconic acid, aconitic acid, fumaric acid, monoethylenically unsaturated dicarboxylic acid monoesters comprising 1 to 3 and preferably 1 to 2 carbon atoms, for example monomethyl maleate, vinylsulfonic acid, methallylsulfonic acid, sulfoethyl acrylate, sulfoethyl methacrylate, sulfopropyl acrylate, sulfopropyl methacrylate, 2-hydroxy-3-acryloyloxypropylsulfonic acid, 2-hydroxy-3-methacryloyloxypropylsulfonic acid, styrenesulfonic acids, 2-acrylamido-2-methylpropanesulfonic acid (AMPS), vinylphosphonic acid, α-methylvinylphosphonic acid and allylphosphonic acid and/or their salts;
N-diallylamines, N,N-diallyl-N-alkylamines, acid-addition salts thereof and quaternization products thereof, the alkyl used here preferentially being C1-C3-alkyl;
N,N-diallyl-N-methylamine and N,N-diallyl-N,N-dimethylammonium compounds, for example the chlorides and bromides;
nitrogenous heterocycles substituted with vinyl and allyl, for example N-vinylimidazole, N-vinyl-2-methylimidazole, heteroaromatic compounds substituted with vinyl and allyl, for example 2- and 4-vinylpyridine, 2- and 4-allylpyridine, and salts thereof;
sulfobetaines; and
mixtures and combinations of two or more of the abovementioned monomers.

According to the present description, the term “(meth)acrylate” refers collectively and alternatively to the acrylate and methacrylate and the term “(meth)acrylamide” refers collectively and alternatively to the acrylamide and methacrylamide, so that, for example, “butyl (meth)acrylate” means butyl acrylate and/or butyl methacrylate.

According to a possible embodiment, the polymer chain [A] included in the pre-polymer (p0) is a polymer chain resulting from the polymerization of hydrophilic monomers (mAₕ) only, provided that the pre-polymer (p0) remains soluble in the medium (M).

According to an alternatively embodiment, the polymer chain [A] included in the pre-polymer (p0) comprises some units which are hydrophobic in nature, provided that the pre-polymer (p0) remains, overall, soluble in the medium (M). In that case, the polymer chain [A] generally results from a copolymerization (random or block) of at least one hydrophilic monomer (mAₕ) as defined above with at least one hydrophobic monomer (mA_{H}).

Examples of hydrophobic monomers (mA_{H}) that can be present in the polymer chain [A] of in the pre-polymer (p0) include for example styrene or its derivatives, butadiene, chloroprene, (meth)acrylic esters, vinyl esters of a carboxylic acid, for instance vinyl acetate, vinyl versatate or vinyl propionate, and vinyl nitriles.

The term “(meth)acrylic esters” denotes esters of acrylic acid and of methacrylic acid with hydrogenated or fluorinated C₁-C₁₂ and preferably C₁-C₈ alcohols. Among the compounds of this type that may be mentioned are: methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate

The vinyl nitriles more particularly include those containing from 3 to 12 carbon atoms, such as, in particular, acrylonitrile and methacrylonitrile.

It should be noted that the styrene may be totally or partially replaced with derivatives such as α-methylstyrene or vinyltoluene or tertbutylstyrene.

Other ethylenically unsaturated monomers (mA_{H}) that may be used, alone or as mixtures, or that are copolymerizable with the above monomers include especially:
vinyl halides,
vinylamine amides, especially vinylformamide or vinylacetamide,
N′-alkyl(meth)acylamides of at least C8, N′,N′-dialkyl(meth)acrylamides of at least C6.

The polymer chain [A] of the pre-polymer (p0) has preferably a number-average molar mass of less than 10 000 g/mol, for example, less than 5 000 g/mol, and typically more than the ratio m/p0 used in step (E1). This number-average molar mass can be for example measured by steric exclusion chromatography, using polyethylene glycol as standard or triple detection (GPC).

According to an interesting embodiment, that reveals especially suitable when the dispersion prepared according to steps (E1) and (E2) is intended to be used for the preparation of fabric conditioning composition, the polymer chain [A] of the pre-polymer (p0) comprises cationic monomers Ac and non-ionic monomers An.

The polymer chain [A] may e.g. be a statistical copolymer including monomers Ac and An.

Alternatively, the polymer chain [A] may be a bloc copolymer including a hydrophilic block [Ac] deriving from cationic monomers Ac; and a non-ionic block [An] deriving from non-ionic monomers An

Pre-polymers (p0) having such a bloc structure may typically be obtained by implementing the aforementioned step (E⁰) and making use of:
a radical polymerization control agent of the formula (F) wherein R1 is a polymer chain, namely a first bloc [Ac] or [An];
and
monomers that are, respectively: nonionic monomers An when R1 is a bloc [Ac] and cationic monomers Ac when R1 is a bloc [An].

Suitable cationic monomers Ac especially include quaternary ammonium monomers or salts thereof, e.g. selected from the group consisting in:
Trimethylammoniumpropylmethacrylamide;
(3-methacrylamidopropyl)trimethylammonium;
(3-acrylamidopropyl)trimethylammonium;
Methacryloyloxyethyltrimethylammonium;
acryloyloxyethyltrimethylammonium;
methyldiethylammoniumethyl acrylate;
benzyldimethylammoniumethyle acrylate;
1-ethyl 2-vinylpyridinium;
1-ethyl 4-vinylpyridinium;
N-dimethyldiallylammonium;
dimethylaminopropylmethacrylamide N-(3-chloro-2-hydroxypropyl)trimethylammonium chloride; and
monomers of formula

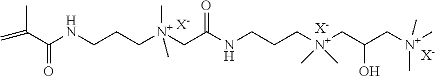

wherein each of X⁻ is an anion, preferably chloride or methylsulfate.

The (3-acrylamidopropyl)trimethylammonium salts are especially suitable monomers Ac.

As regards nonionic monomers An, they are preferably selected from (meth)acrylamides and derivatives or (meth)acrylic acids and derivatives, more preferably from (meth)acrylamides.

A suitable pre-polymer (p0), exemplified hereinafter, is a pre-polymer wherein the chain [A] is a statistical copolymer of acrylamide (AM) and (3-acrylamidopropyl)trimethylammonium chloride (APTAC).

Whatever its exact composition, the pre-polymer (p0) used in step (E1) may typically be obtained by a preparation step (E⁰) of controlled radical polymerization of a composition comprising:
monomers containing (and usually consisting of) identical or different (generally identical) hydrophilic monomers (mAₕ) preferably as defined above, optionally together with at least one hydrophobic monomer (mA_{H}) preferably as defined above;
a radical polymerization control agent including a group (R¹¹)x-Z¹¹—C(═S)—Z²—, wherein R¹¹, x, Z¹¹, and Z¹² being defined above, (preferably xanthate, dithiocarbamate, dithiocarbazate, trithiocarbonate, dithioester or dithiobenzoate); and
a free-radical polymerization initiator which is typically as defined here-after.

The group (R¹¹)x-Z¹¹—C(═S)—Z¹²— of pre-polymer (p0), which may especially be a thiocarbonylthio group, is typically introduced via the control agent used in the controlled radical polymerization performed in the above-mentioned step (E⁰), which is typically a RAFT or MADIX control agent.

The radical polymerization control agent used in step (E⁰) may advantageously have the formula (F) below:

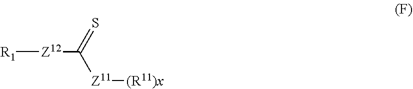

wherein:
R¹¹, x, Z¹¹, and Z¹² being defined above for pre-polymer (p0); and
R₁ represents:
   an optionally substituted alkyl, acyl, aryl, aralkyl, alkene or alkyne group,
   a saturated or unsaturated, aromatic, optionally substituted carbocycle or heterocycle, or
   a polymer chain.
      R1, when substituted, may be substituted with optionally substituted phenyl groups, optionally substituted aromatic groups, saturated or unsaturated carbocycles, saturated or unsaturated heterocycles, or groups selected from the following: alkoxycarbonyl or aryloxycarbonyl (—COOR), carboxyl (—COOH), acyloxy (—O2CR), carbamoyl (—CONR2), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR2), halogen, perfluoroalkyl CnF2n+1, allyl, epoxy, alkoxy (—OR), S-alkyl, S-aryl, groups of hydrophilic or ionic nature such as alkali metal salts of carboxylic acids, alkali metal salts of sulfonic acid, polyalkylene oxide chains (PEO, PPO), cationic substituents (quaternary ammonium salts), R representing an alkyl or aryl group, or a polymer chain.

According to one particular embodiment, R, is a substituted or unsubstituted, preferably substituted, alkyl group.

The optionally substituted alkyl, acyl, aryl, aralkyl or alkyne groups to which reference is made in the present description generally contain 1 to 20 carbon atoms, preferably 1 to 12 and more preferentially 1 to 9 carbon atoms. They may be linear or branched. They may also be substituted with oxygen atoms, in particular in the form of esters or sulfur or nitrogen atoms.

Among the alkyl radicals, mention may be made especially of methyl, ethyl, propyl, butyl, pentyl, isopropyl, tert-butyl, pentyl, hexyl, octyl, decyl or dodecyl radicals.

For the purposes of the present description, the alkyne groups are radicals generally containing from 2 to 10 carbon atoms, and contain at least one acetylenic unsaturation, such as the acetylenyl radical.

For the purposes of the present description, the acyl groups are radicals generally containing from 1 to 20 carbon atoms with a carbonyl group.

Among the aryl radicals which may be used according to the invention, mention may be made in particular of the phenyl radical, optionally substituted especially with a nitro or hydroxyl function.

Among the aralkyl radicals, mention may be made in particular of the benzyl or phenethyl radical, optionally substituted especially with a nitro or hydroxyl function.

When R, is a polymer chain, this polymer chain may be derived from a radical or ionic polymerization or derived from a polycondensation.

Advantageously, in step (E⁰), the radical polymerization control agent is a xanthate compound, for instance O-ethyl-S-(1-methoxycarbonyl ethyl) xanthate of formula (CH₃CH(CO₂CH₃))S(C═S)OCH₂CH₃.

A control agent that is particularly suited to the implementation of step (E⁰) is the compound sold by the company Solvay under the name Rhodixan® A1.

The Free-Radical Polymerization Initiator

Any source of free radicals which is known per se as being suitable for polymerization processes in a medium comprising water miscible solvent may be used in steps (E⁰) and (E1) of the polymerization of the invention.

The radical polymerization initiator may, for example, be selected from the following initiators:
peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, potassium persulfate, ammonium persulfate,
azo compounds such as: 2-2′-azobis(isobutyronitrile), 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis(2-méthyl-N-hydroxyethyl]propionamide, 2,2′-azobis(N,N′-dimethyleneisobutyramidine)dichloride, 2,2′-azobis(2-amidinopropane)dichloride, 2,2′-azobis(N,N′-diméthyleneisobutyramide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide] or 2,2′-azobis(isobutyramide)dihydrate,
redox systems comprising combinations such as:
mixtures of hydrogen peroxide, alkyl peroxide, peresters, percarbonates and the like and any iron salts, titanous salts, zinc formaldehyde sulfoxylate or sodium formaldehyde sulfoxylate, and reducing sugars,
alkali metal or ammonium persulfates, perborate or perchlorate in combination with an alkali metal bisulfite, such as sodium metabisulfite, and reducing sugars, and
alkali metal persulfates in combination with an arylphosphinic acid, such as benzenephosphonic acid and the like, and reducing sugars.

According to one advantageous embodiment, use may be made of a radical initiator of redox type, which has the advantage of not requiring specific heating of the reaction medium (no thermal initiation). It is typically a mixture of at least one water-soluble oxidizing agent with at least one water-soluble reducing agent.

The oxidizing agent present in the redox system may be selected, for example, from peroxides such as: hydrogen peroxide, tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, sodium persulfate, potassium persulfate, ammonium persulfate or potassium bromate.

The reducing agent present in the redox system may typically be selected from sodium formaldehyde sulfoxylate (in particular in dihydrate form, known under the name Rongalit, or in the form of an anhydrite), ascorbic acid, erythorbic acid, sulfites, bisulfites or metasulfites (in particular alkali metal sulfites, bisulfites or metasulfites), nitrilotrispropionamides, and tertiary amines and ethanolamines (which are preferably water-soluble).

Possible redox systems comprise combinations such as:

mixtures of water-soluble persulfates with water-soluble tertiary amines,

mixtures of water-soluble bromates (for example alkali metal bromates) with water-soluble sulfites (for example alkali metal sulfites),

mixtures of hydrogen peroxide, alkyl peroxide, peresters, percarbonates and the like and any iron salts, titanous salts, zinc formaldehyde sulfoxylate or sodium formaldehyde sulfoxylate, and reducing sugars,

alkali metal or ammonium persulfates, perborate or perchlorate in combination with an alkali metal bisulfite, such as sodium metabisulfite, and reducing sugars, and

alkali metal persulfates in combination with an arylphosphinic acid, such as benzenephosphonic acid and the like, and reducing sugars.

An advantageous redox system comprises (and preferably consists of) for example a combination of ammonium persulfate and sodium formaldehyde sulfoxylate.

Another advantageous initiator is or comprises sodium persulfate NaPS.

The Monomers (m) Used in Step (E1)

The ethylenically unsaturated hydrophobic monomer (m) used in step (E1) may advantageously be selected from the group consisting of:
methyl (meth)acrylate, ethyl (meth)acrylate, butyl (meth)acrylate, isobutyl (meth)acrylate, cyclohexyl (meth)acrylate, 2-ethylhexyl (meth)acrylate, isodecyl (meth)acrylate, lauryl (meth)acrylate isobornyl (meth)acrylate, benzyl (meth)acrylate, ethoxyethyl (meth)acrylate, phenoxyethyl (meth)acrylate, glycidyl (meth)acrylate, tert-butylaminoethyl (meth)acrylate, and acetoxyethyl (meth)acrylate, (meth)acrylamides such as, (meth)acrylamide, N-butoxyethyl (meth)acrylamide, N,N-dimethyl (meth)acrylamide, N-isopropyl (meth)acrylamide, N-tert-butyl (meth)acrylamide, N-tert-octyl (meth)acrylamide, diacetone (meth)acrylamide, vinyl acetate, vinyl propionate, vinyl 2-ethylhexanoate, vinyl butanoate, vinyl versatate, ethylene and styrene;
mixtures thereof.

More preferably, the ethylenically unsaturated hydrophobic monomers (m) comprise alkyl (meth)acrylates containing less than 30, for example from 4 to 30 carbon atoms, notably between 8 to 24, carbon atoms, and mixtures thereof. For example it may be selected from the group consisting of butyl acrylate; 2-ethylhexyl acrylate; and their mixtures.

According to a specific embodiment, the step (E1) may be a copolymerization step using co-monomers (m′) in addition to one or more monomers (m). In that case, co-monomers (m′) may be selected from the list consisting of:
hydrophobic monomers including styrene or its derivatives, butadiene, chloroprene, (meth)acrylic esters, vinyl esters of a carboxylic acid, for instance vinyl acetate, vinyl versatate or vinyl propionate, and vinyl nitriles, vinyl halides, vinylamine amides, especially vinylformamide or vinylacetamide, N′-alkyl(meth)acylamides of at least C8, N′,N′-dialkyl(meth)acrylamides of at least C6,
hydrophilic monomers as defined here-above for monomer (mAₕ), and
mixture thereof.

These co-monomers (m′) may be chosen depending on the specific use of the polymer dispersion of the invention. Typically, the ratio by weight (m)/(m′) of the monomer(s) (m) to the co-monomer(s) (m′) present in the polymer dispersion is at least 50:50, for example at least 55:45, e.g. at least 60:40 or 75:25 in some cases.

According to one embodiment of the invention, only one kind of monomers is used in the medium (M) to form a homopolymer.

According to one embodiment of the invention, at least two monomers (namely at least two kinds of monomers) are used to form a random, gradient or block copolymer.

The Step (E2)

Step (E2) is a deactivation step: during this step, the terminal group that imparts the living character of the polymer chains obtained in step (E1) are converted into another terminal group that do not impart this living properties.

This deactivation of the terminal group (R¹¹)ₓ—Z¹¹—C(═S)—Z¹²— may be made by any method known per se, for example according to one of the method described in patent applications WO 02/090397, FR 2 829 140, WO 03/065803 or WO 2005/040233.

Typically, step (E2) comprise the addition of a peroxide or a peracid to the dispersion obtained in step (E1). At low pH, a peracid will be typically used, for example peracetic acid.

At high pH, hydrogen peroxide would be preferable.

Use of the Dispersion (D⁰)

The dispersions (D⁰) of the invention are typically used for dispersing hydrophobic monomers (leading to dispersion (D) comprising said hydrophobic monomers), leading after polymerization to dispersion of polymers (Dp). Hydrophobic species such as e.g. perfumes may be added to the obtained dispersion (D) and (Dp).

In the specific domain of fabric conditioning composition, the dispersions (D⁰) and (Dp) may be potentially used:
as such, a dispersion (D⁰) may impart at least a partial conditioning effect on a fabric, especially when:
   the hydrophilic bloc contained in the copolymers of (D⁰), namely the polymer chain [A] in the pre-polymers used in step (E1), comprises cationic monomers Ac and non-ionic monomers An of the aforementioned type;
   and
   the monomers (m) include alkyl (meth)acrylates containing less than 30, preferably from 8 to 24, carbon atoms, for example butyl acrylate and/or 2-ethylhexyl acrylate.

According to a specifically interesting mode, illustrated in the appended examples, a dispersion (Dp) may be used. In this connection, the dispersion (Dp) is preferably prepared by polymerizing in step (E4) of a dispersion (D) prepared in step (E3) by mixing a dispersion (D0) with hydrophobic species that are hydrophobic similar or identical to the monomers (m) used for preparing the dispersion (D⁰).

Preferably, both the monomers (m) used in step (E1) and the hydrophobic species used in step (E3) are monomers including alkyl (meth)acrylates containing less than 30, preferably from 8 to 24, carbon atoms, for example butyl acrylate and/or 2-ethylhexyl acrylate. As illustrated in the examples, the polymer dispersions (Dp) obtained accordingly exhibit very good softening properties.

The following examples are given as an illustration of possible interesting embodiments of the invention.

### EXAMPLES

### Example 1

### Preparation of a Pre-Polymers (Macro Transfer Agents) Useful According to the Invention

### Example 1.1

### Preparation of a pre-polymer composition MCTA 1

In a 2000 mL glass bottle were introduced: 441.7 g of 50% wt water solution of Acrylamide (AM) 105.7 g of a 75% wt water solution of (3-acrylamidopropyl)trimethylammonium chloride (APTAC); and 448.3 g of demineralized water. The pH (initially equal to 6.49) was then adjusted to pH=3.03, by addition of H₂SO₄ (10% wt water solution).

12.5272 g of Rhodixan® A1 (Solvay) and 195.9 g of ethanol were then added, that turns the obtained mixture to be cloudy. After 10 min of strong agitation, 1.6254 g of V50 initiator were added.

The obtained mixture was introduced in a 2000 mL double-jacketed glass vessel equipped with an agitation anchor, a nitrogen inlet, a temperature sensor and a condensor.

Nitrogen was introduced (bubbling) during 30 min at room temperature (25° C.) and then the reaction medium was heated at 63° C. within 30 min. A marked exothermicity was observed around 50° C. The nitrogen was then used a nitrogen blanket and the temperature of 63° C. was maintained during 10 h.

The reaction medium was then cooled down to 23° C. within 30 min and let at room temperature overnight. A viscous liquid was then obtained, having a dry extract of 29.84%.

Ethanol and a part of the water were evaporated (rotavapor—55° C., 50 mbar), leading to a composition MCTA1, having a dry extract of 48.3% (measured with a thermobalance—1 h, 130° C.).

The awaited molar composition of the polymer (90/10 in mol for AM/APTAC) has been confirmed by RMN ¹H, that also indicates a Mn of about 6 700 g/mole.

### Example 1.2

### Preparation of a pre-polymer composition MCTA 2

In a 2000 mL double-jacketed glass vessel equipped with an agitation mobile, a nitrogen inlet, a temperature sensor and a condensor, 29.45 g of a 50% wt water solution of AM; 7.03 g of a 75% wt water solution of APTAC; and 248 g of demineralized water were introduced. The pH (initially equal to 3.66) was then adjusted to pH=2.92, by addition of H₂SO₄ (10% wt water solution). 41.66 g of Rhodixan® A1 (Solvay) and 166.63 g of ethanol were then added.

Nitrogen was introduced (bubbling) during 45 min at room temperature (25° C.) and then the reaction medium was heated at 63° C. within 60 min.

When the temperature has reached 63° C., 5.42 g of a 5% water solution of V50 was added and the following parallel injections were started:
1952.99 g of a first solution water solution of AM (50% in water—for a total of 1442.95 g) and APTAC (75% in water, for a total of 344.70 g) was continuously added within 240 minutes;
48.81 g of a second water solution of V50 (5% in water) was added within 240 minutes

The temperature of 63° C. was maintained during 8 h. A very marked exothermicity was observed. The reaction medium was cooled down to 20° C. within 60 min and let at this temperature overnight.

A liquid (=composition MCTA2) was then obtained, having the following features:
Dry extract (thermobalance—120 min 130° C.): 44.00%
Mₙ=5300 g·mol⁻¹ (measured by RMN).

### Example 2

### Use of the Pre-Polymers of Example 1 for Preparing Dispersions (D0) According to the Invention

### Example 2.1

### Preparation of a Dispersion D0-1 from the Composition MCTA1 of Example 1.1

192.8 g of the composition MCTA1 of example 1.1, 27.96 g of butyl acrylate (ABu), 414.3 g of demineralized water and 0.71 g of an aqueous solution of sodium persulfate (NaPS) having a NaPS concentration of 10% wt were mixed in a 600 mL glass beaker and then transferred in a 1000 mL double-jacketed glass vessel equipped with an lightning type agitation, a nitrogen inlet and a condensor.

Nitrogen was introduced (bubbling) during 1 h at room temperature (25° C.) and then the reaction medium was heated at 75° C. within 1 h. After 20 minutes of heating, 56.7 g of the composition MCTA1 of example 1.1 and 21.6 g of demineralized water were added to the reaction medium.

When the temperature has reached 75° C., 6.22 mL of a 10% wt water solution of NaPS are added from a syringe pump within 2 hours, and 162.46 mL d'ABu are added from a second syringe pump within 2.5 hours.

At the end of the injections, the reaction medium is let during 2 hours at 75° C. and then cooled down overnight.

The glass vessel is unloaded and an homogeneous white latex having a pH of about 3-4 is obtained, referred herein as D0-1-Xa, without any crusts visible on the stirring blade.

517.9 g of the obtained D0-1-Xa latex are re-introduced in the glass vessel and then heated to 70° C. within 1 h, and then 9.68 g of peracetic acid (35% wt aqueous solution) are added within 1 h. The reaction medium is let 1 h at 70° C. after the end of the addition of the peracetic acid.

A white latex is then obtained, referred herein as D0-1, having the same visual appearance as D0-1-Xa.

UV analysis indicates that a complete dexanthatation occurred. And a light scattering measure confirms that the particle size is unchanged in comparison to D0-1-Xa.

The latex D0-1 exhibits the following features:
Dry extract (thermobalance—150 min 130° C.): 33.54%
Average particle size (SLS—Nanosizer malvern): 252.5 nm

### Example 2.2

### Preparation of a Dispersion D0-2 from the Composition MCTA2 of Example 1.2

675.7 g of the composition MCTA2 of example 1.2, 41.92 g of butyl acrylate (ABu), 685 g of demineralized water and 1.03 g of an aqueous solution of sodium persulfate (NaPS) having a NaPS concentration of 10% wt were introduced in a 2000 mL double-jacketed glass vessel equipped with an agitation mobile, a nitrogen inlet, a temperature sensor and a condensor.

Nitrogen was introduced (bubbling) during 1 h at room temperature (25° C.) and then the reaction medium was heated at 75° C. within 1 h.

When the temperature has reached 75° C., 9.345 g of a 10% wt water solution of NaPS are added from a syringe pump within 2.5 hours, and 237.56 g of ABu are added from a second syringe pump within 2 hours.

At the end of the injections, the reaction medium is let during 2 hours at 75° C. and then cooled down overnight.

The glass vessel is unloaded and an homogeneous white latex having a pH of about 3-4 is obtained, referred herein as D0-2-Xa.

1621.97 g of the obtained D0-2-Xa are re-introduced in the glass vessel and then heated to 70° C. within 1 h, and then 35.98 g of peracetic acid (35% wt aqueous solution) are added within 1 h The reaction medium is let 1 h at 70° C. after the end of the addition of the peracetic acid.

A white latex is then obtained, referred herein as D0-2, having the same visual appearance as D0-2-Xa.

This latex D0-2 exhibits the following features:
Dry extract (thermobalance—75 min 115° C.): 35.38%
Average particle size (SLS—Nanosizer malvern): 95.42 nm (PDI=0.094)

### Example 3

### Use of the Dispersions of Example 2 for Preparing Dispersions of Polymers (Dp) According to the Invention

### Example 3.1

### Preparation of a Dispersion Dp-1 (Latex) from the Dispersion D0-1 of Example 2.1

78.5 g of the dispersion D0-1 of example 2.1 and 191 g of demineralized water were mixed in a 600 mL glass beaker and then transferred in a in a 500 mL double-jacketed glass vessel equipped with an lightning type agitation, a nitrogen inlet and a condenser Nitrogen was introduced (bubbling) during 1 h at room temperature (25° C.) and then the reaction medium was heated at 70° C. within 1 h.

When the temperature has reached 70° C., 2.8970 g of a 10% wt water solution of NaPS and 86.406 mL of ABu are added from a syringe pump within 4 hours. The reaction medium is then cured 2 h at 70° C. after the end of the addition.

An homogeneous latex Dp-1 is then obtained, having the following features:
Dry extract (thermobalance—60 min, 130° C.): 30.03%
Average particle size (SLS—Nanosizer malvern): 172.8 nm
Residual ABu (gas chromatography): 610 ppm

### Example 3.2

### Preparation of a Dispersion Dp-2 (Latex) from the Dispersion D0-2 of Example 2.2

252.65 g of the dispersion D0-2 of example 2., 530.52 g of demineralized water and 3.36 g of tert-dodecylmercaptan (TDM) were introduced in a 2000 mL double-jacketed glass vessel equipped with an agitation mobile, a nitrogen inlet, a temperature sensor and a condensor.

Nitrogen was introduced (bubbling) during 1 h at room temperature (25° C.) and then the reaction medium was heated at 70° C. within 1 h.

When the temperature has reached 70° C., 7.78 g of a 10% wt water solution of NaPS was added as a shot and then 209.28 g of ABu were added within 4 hours. The reaction medium is then cured 2 h at 70° C. after the end of the addition of ABu.

An homogeneous latex Dp-2 is then obtained, having the following features:
Dry extract (thermobalance—60 min, 130° C.): 30.3%
Average particle size (SLS—Nanosizer malvern): 93.31 nm (PDI=0.101)
Residual ABu (gas chromatography): 1221 ppm

### Example 3.3

### Preparation of a Dispersion Dp-3 (Latex) from the Dispersion D0-2 of Example 2.2

252.65 g of the dispersion D0-2 of example 2., 517.30 g of demineralized water and 16.80 g of TDM were introduced in a 2000 mL double-jacketed glass vessel equipped with an agitation mobile, a nitrogen inlet, a temperature sensor and a condensor.

Nitrogen was introduced (bubbling) during 1 h at room temperature (25° C.) and then the reaction medium was heated at 70° C. within 1 h.

When the temperature has reached 70° C., 7.78 g of a 10% wt water solution of NaPS was added as a shot and then 209.28 g of ABu were added within 4 hours. The reaction medium is then cured 2 h at 70° C. after the end of the addition of ABu.

An homogeneous latex Dp-3 is then obtained, having the following features:
Dry extract (thermobalance—60 min, 130° C.): 32.30% Average particle size (SLS—Nanosizer malvern): 94.22 nm (PDI=0.077)
Residual ABu (gas chromatography): 1005 ppm

### Example 4

### Use of the Dispersions Dp-1, Dp-2 and Dp-3 of Example 3 for a Fabric Treatment

The dispersions of latex as obtained in Example 3 were used for a fabric treatment.

Each of the dispersions Dp-1, Dp-2 and Dp-3 of example 3 was first diluted with water to a concentration of 0.2 wt. %, and then left for 12 hours at 25° C. Then, each of the obtained diluted dispersions was again diluted down with water to a concentration of 0.004 wt. % for the fabric treatment, thus leading to three fabric treatment compositions referred as C1, C2 and C3 (C1 correspond to the twice diluted dispersion Dp-1, C2 correspond to the twice diluted dispersion Dp-2, and C3 correspond to the twice diluted dispersion Dp-3).

The composition were used for treating 40 g Fabric (with 1000 ml of composition) in the conditions described herein-after.

For sake of comparison, the softening performance of the compositions C1, C2 and C3 were compared to a positive Benchmark (PBM) and to a negative benchmark (NBM), defined herein-after, used in the same conditions.

### 4.1. Materials

### 4.1.1 The Treated Fabrics

Cotton terry towels with approximate size 20×20 cm were used

### 4.1.2. The Positive Benchmark PBM (Comparative)

A fabric treatment composition was used as a positive benchmark containing the commercially available quat Fentacare® TEP-88 of formula:

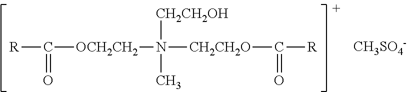

at the same weight concentration as in the compositions C1, C2 and C3.

### 4.1.3. The Negative Benchmark NBM (Comparative)

Pure water (without any additive) was used as the negative Benchmark

### 4.2. Fabric Treatment

The fabrics were treated in a two-part procedure

(A) Treatment with the Tested Composition (C1, C2, C3, PBM or NBM).
1) 3 pieces of fabric with approximate weight of ˜ 40 grams were put into the vessel of a tergotometer. If the weight of the fabrics does not add up to 40 g an additional small piece is added in order for the total weight of the fabrics to be 40 g. This additional piece is not used in the softness evaluation.
2) 1000 ml of the tested composition (C1, C2, C3, PBM or NBM) were added
3) The fabrics were soaked for 10 minutes at speed of rotation of the tergotometer of 75 rpm at temperature of 25±1° C.

(B) Drying and Conditioning.
1) The fabrics as obtained at the end of step (A) are spin-dried for 10 minutes at 720 rpm in spin-dryer (Samsung Washing Machine, Model No: WA90F5S9).
2) The fabrics are hanged on a clothes rack in a special room (humidity: 60±5%; temperature: 20±1° C.). The fabrics are well-separated (at least one bar distance) from each other in order to avoid contamination.

### 4.3. Softness Assessment

The softness was assessed in a panel of 6 people. The panellists assign a number from 1 to 5 characterizing the softness, higher score corresponds to better softness.

The panels included 4 samples:
(1) One sample of fabrics treated with the Negative benchmark (NBM), namely with no softening formulation added (only treated with water). The typical softness score assigned to the negative benchmark is in the range of ≈2.4÷2.6.
(2) One sample of fabrics treated with the Positive benchmark (PBM). The score of positive benchmark is in the range ≈3.6÷3.9
(3) 2 sample of fabrics treated with one of composition C1, C2 or C3.

Each fabric is touched only 3 times. The number of touches has to be limited as touching the fabric can lead to increase in softness. We have a total of 18 determinations of the softness for each system. The softness is calculated as an average of the 18 values. The standard deviation of the measurement is calculated in the following manner

$$S {D}_{P} = \sqrt{\frac{( {n}_{1} - 1 ) S {D}_{1}^{2} + ( {n}_{2} - 1 ) S {D}_{2}^{2} + … + ( {n}_{k} - 1 ) S {D}_{k}^{2}}{{n}_{1} + {n}_{2} + … + {n}_{k} - k}}$$

Here SD_{P} is the so-called pooled standard deviation; SD₁, SD₂, SD_{K} are the standard deviations for each group; n₁, n₂, nₖ are the number of fabrics in each group. In our case we have 3 groups each containing the same number of fabrics (6). SD₁, SD₂ and SD₃ are the standard deviations of the determination of the score from the 1^{st}, 2^{nd} and 3^{rd} touch, respectively. The above equation can be written as follows:

$$S {D}_{P} = \sqrt{\frac{S {D}_{1}^{2} + S {D}_{2}^{2} + S {D}_{3}^{2}}{3}}$$

The standard error for each system is calculated via the following equation:

$$S {E}_{P} = \frac{S {D}_{P}}{\sqrt{N}}$$

Here N=18 is the total number of the measurements (or touches here).

The softness score assigned to a studied sample is not an absolute value, and makes sense only when compared to the values of the positive and negative benchmark. However the values of the softness score of the PBM and NBM vary in a certain range. Therefore a direct comparison between the softness scores of samples studied in different panels is misleading. A correct comparison would reflect the degree in which the compared samples differ from the PBM and the NBM. In order to be able to compare systems studied in different panels we introduced a parameter called softness degree, SDG:

$$SDG = \frac{Score ( studied system ) - Score ( NBM )}{Score ( PBM ) - Score ( NBM )} \times 100$$

The SDG is measured in percent. The NBM and PBM have 0% and 100% SDG, respectively. The majority of the studied systems have SDG in the range 0÷100%, some exceptionally well performing systems have SDG>100%.

The standard error of the softness degree is calculated via the standard rules for error propagation:

Δ(a±b)=\sqrt{Δa²+Δb²}

Δ(a/b)=(a/b)\sqrt{(Δa/a)²+(Δb/b)²}

Softness degree of the studied latexes at the working concentration (1×C_{W}).

| Used composition | Softness degree, | SE_{P} |
|---|---|---|
| C1 | 58% | 14% |
| C1 | 64% | 7% |
| C1 | 69% | 5% |

1. A process for preparing a dispersion (D⁰), comprising the following successive steps:
(E1) a free radical polymerization is performed in an aqueous medium (M) in the presence of:
at least a pre-polymer (p0) soluble in the medium (M), having the following formula (I):
(R¹¹)ₓ—Z¹¹—C(═S)—Z¹²-[A]-R¹² (I)
wherein:
Z¹¹ represents C, N, O, S or P,
Z12 represents S or P,
R11 and R12, which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii), these groups and rings (i), (ii) and (iii) being optionally substituted with substituted phenyl groups, substituted aromatic groups or groups: alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR₂), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts),
R representing an alkyl or aryl group,
x corresponds to the valency of Z¹¹, or alternatively x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR₂); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR₂); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts); and
[A] represents a polymer chain; and
at least one free-radical polymerization initiator; and
at least one ethylenically unsaturated hydrophobic monomer (m)
with a ratio m/p0 of the mass of the monomers (m) to the quantity of pre-polymer (p0) below 10 000 g/mol.
whereby a dispersion of copolymers is obtained, including polymer chains having a (R¹¹)ₓ—Z¹¹—C(═S)—Z¹²— terminal group, that confer to these chains a living character;
and then
(E2) the (R¹¹)ₓ—Z¹¹—C(═S)—Z¹²— terminal groups present in the dispersion of copolymers as obtained in step (E1) are converted into other groups that deprive the copolymers of their living character.

2. The process according to claim 1, wherein the ratio m/p0 of the mass of the monomers (m) to the quantity of pre-polymer (p0) is between 5,000 and 10.000 g/mol.

3. The process according to claim 1, wherein the polymer chain [A] of the pre-polymer (p0) comprises:
cationic monomers Ac, selected from the group consisting in:
Trimethylammoniumpropylmethacrylamide;
(3-methacrylamidopropyl)trimethylammonium;
(3-acrylamidopropyl)trimethylammonium;
Methacryloyloxyethyltrimethylammonium;
acryloyloxyethyltrimethylammonium;
methyldiethylammoniumethyl acrylate;
benzyldimethylammoniumethyle acrylate;
1-ethyl 2-vinylpyridinium;
1-ethyl 4-vinylpyridinium;
N-dimethyldiallylammonium;
dimethylaminopropylmethacrylamide N-(3-chloro-2-hydroxypropyl)trimethylammonium chloride; and
monomers of formula of 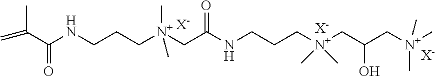
where each of X⁻ is an anion, is chloride or methylsulfate;
and
non-ionic monomers An.

4. The process of claim 3, wherein the chain [A] is a statistical copolymer of acrylamide (AM) and (3-acrylamidopropyl)trimethylammonium chloride (APTAC).

5. The process according to claim 1, wherein the pre-polymer (p0) is obtained by a preparation step (E⁰) of controlled radical polymerization of a composition comprising:
monomers containing identical or different hydrophilic monomers mAh as defined above, optionally together with at least one hydrophobic monomer mAH
a radical polymerization control agent including a group (R¹¹)x-Z¹¹—C(═S)—Z²—, wherein R¹¹, x, Z¹¹, and Z¹² are as defined in claim 1; and
a free-radical polymerization initiator.

6. The process according to claim 5, wherein the monomers (m) comprise alkyl (meth)acrylates containing less than 30 carbon atoms.

7. The process according to claim 1, wherein step (E2) comprise the addition of a peroxide or peracid to the dispersion obtained in step (E1).

8. A dispersion (D⁰) obtainable according to the process of claim 1.

9. An aqueous medium comprising a dispersion (D⁰) according to claim 8 and hydrophobic monomers.

10. A process for preparing a dispersion (D) of hydrophobic monomers in an aqueous medium, comprising the preparation of a dispersion (D⁰) according to the process of claim 1 and then a step (E3) wherein said dispersion D⁰ is contacted with the hydrophobic monomers.

11. A dispersion (D) of hydrophobic monomers in an aqueous medium, obtainable according to the process of claim 10.

12. A process for preparing a dispersion (Dp) of hydrophobic polymer in an aqueous medium, that comprises a step (E4) wherein all of part of the hydrophobic monomers contained in a dispersion (D) according to claim 11 are polymerized.

13. A dispersion (Dp) of hydrophobic polymers in an aqueous medium obtainable according to the process of claim 12.

14. A fabric conditioning composition comprising the dispersion (D⁰) according to claim 8.

15. A fabric conditioning composition comprising the dispersion (Dp) according to claim 13.

16. The process according to claim 6, wherein the non-ionic monomers An are selected from (meth)acrylamides and derivatives or (meth)acrylic acids and derivatives

17. The process according to claim 6, wherein the monomers (m) comprise butyl acrylate and/or 2-ethylhexyl acrylate.
